(19) United States
(12) Patent Application Publication
(10) Pub. No.: US 2019/0081659 A1
(43) Pub. Date: Mar. 14, 2019

(54) METHOD FOR AN OPTICAL ACHIEVABLE DATA RATE FOR WIRELESS COMMUNICATIONS

(71) Applicants: University of Southern California, Los Angeles, CA (US); King Abdulaziz City for Science and Technology Kingdom of Saudi Arabia, Riyadh (SA)

(72) Inventors: Vishnu Ratnam, Los Angeles, CA (US); Andreas Molisch, Los Angeles, CA (US); Hatim Behairy, Riyadh (SA); Faisal Alawwad, Riyadh (SA); Naif Rabeah, Riyadh (SA)

(21) Appl. No.: 16/127,002

(22) Filed: Sep. 10, 2018

Related U.S. Application Data
(60) Provisional application No. 62/556,913, filed on Sep. 11, 2017.

(51) Int. Cl. H04B 1/7117; H04B 7/08; H04L 5/00; H04B 7/06

(52) U.S. Cl. CPC H04B 1/7117; H04B 7/088; H04B 2201/70701; H04B 7/0626; H04L 5/0048

(57) ABSTRACT

Systems, methods and apparatus for an optimal achievable performance criterion for a wireless communication system. A method may include determining a joint average channel characteristic for each diversity branch of a plurality of diversity branches. The method may further include determining an optimal size of a first subset of the plurality of diversity branches based on the joint average channel characteristics. The method may further include determining an optimal choice for the first subset based on the joint average channel characteristics. The method may further include determining a number of pilot transmissions required based on the optimal choice of diversity branches for the first subset. The method may further include determining a second subset of the plurality of diversity branches based on instantaneous channel state information.

### CROSS-REFERENCE TO RELATED APPLICATIONS

This application claims priority to and the benefit of U.S. Provisional Patent Application No. 62/556,913 titled “SYSTEM DESIGN AND ALGORITHM FOR JUDICIOUS PILOT TRAINING IN LOW COMPLEXITY TRANSCEIVERS,” filed on Sep. 11, 2017, the entire contents of the application is hereby incorporated by reference herein for all purposes.

### BACKGROUND

### 1. Field

This specification relates to systems, methods, and apparatus for an optimal achievable data rate for wireless communications.

### 2. Description of the Related Art

Diversity, e.g., in the form of spatial (antenna) diversity or delay diversity, is a method to reduce the negative impact of fading in wireless communications systems. The general trend towards larger number of antennae and/or wider bandwidths means that the number of diversity branches is increasing. For example, a massive multiple-input-multiple-output (MIMO) base station might have 100 antenna elements, or an ultra wideband (UWB) receiver might have approximately 100 resolvable delay bins.

While such a high number of diversity branches bring performance advantages, the associated commensurate increase in the number of up/down-conversion chains drastically increases the implementation cost and energy consumption in the transceivers. As a solution, low complexity switched transceivers have been proposed, such as hybrid digital-analog beamforming with selection and Selective-Rake receiver. In such systems, the number of up/down-conversion chains (K) are fewer than the number of diversity branches the channel offers and an array of switches select K out of the N diversity branches for down-conversion.

For such a low-complexity receiver, assuming a single antenna transmitter and in the absence of interference, the capacity optimal way for combining the received signals is generalized selection combining (GSC). This is also known as hybrid selection or maximum ratio combining. In GSC, the instantaneously strongest K diversity branches are down-converted and maximum-ratio combined. The performance of a GSC system has been studied in great detail for independent Rayleigh fading, Nakagami-m fading, and arbitrary fading channels. In the presence of multiple data streams in a multi-antenna system, the capacity-optimal reception is a selection of a subset of antennas, followed by a spatial-multiplexing receiver (e.g., a maximum-likelihood receiver) with K inputs. Generally, optimization might be done with respect to capacity, or other criteria might be used, but the overall receiver structure is always a combination of a selection of K branches, followed by a “standard” K-branch receiver. In the following, we will describe GSC with optimization of capacity for the purpose of concreteness, but the principle can be applied to all other selection receiver types as well.

For implementing GSC, the receiver (RX) needs the channel state information (CSI) for all the diversity paths. The CSI can be acquired by transmitting a known pilot sequence from the transmitter (TX) during each channel coherence time interval. However, for low complexity systems, since the RX has only K<N down-conversion chains, for each transmitted pilot sequence the RX can acquire CSI for only K diversity paths. Therefore, the pilot sequence has to be re-transmitted N/K times to acquire the CSI for all the diversity paths. This overhead for training can be especially large when N>>K, the pilot sequence is long and/or the channel coherence time is short.

Accordingly, these and other drawbacks provide a need for a system and a method to minimize the impact of this training overhead in order to provide an optimal achievable data rate for wireless communications.

### SUMMARY

In general, one aspect of the subject matter described in this specification is embodied in a method for an optimal performance criterion for a wireless communication system. The methods described herein throughout this disclosure may be implemented using hardware such as one or more amplifiers, antennas, decoders, demulitplexers, diversity branches, encoders, multiplexers, processors, rake receivers or fingers, receivers, signal boosters, transmitters, and/or transceivers. The method includes determining a joint average channel characteristic for each diversity branch of a plurality of diversity branches, at least one diversity branch of the plurality of diversity branches having a signal. The method also includes determining an optimal size of a first subset of the plurality of diversity branches based on the joint average channel characteristics. The method also includes determining an optimal choice of diversity branches for the first subset based on the joint average channel characteristics. The method also includes determining a number of pilot transmissions required based on the optimal choice of diversity branches for the first subset. The method also includes determining instantaneous channel state information for each diversity branch of the first subset based on the pilot transmissions. The method also includes determining a second subset of the plurality of diversity branches based on the instantaneous channel state information, the second subset being a subset of the first subset. The method also includes performing an up/down-conversion on the second subset. The method also includes decoding one or more signals based on the second subset.

These and other embodiments may include one or more of the following features. The instantaneous channel state information utilized for choosing the second subset of diversity branches may be the instantaneous power. The method may also include transmitting a known pilot sequence one or more times during a channel coherence time interval. The method may also include receiving channel state information in response to transmitting the known pilot sequence. The method may also include determining the number of pilot retransmissions based on choice of the first subset of diversity branches. The method may also include determining that there are two or more signals in the second subset. The method may also include combining the two or more signals of the second subset for decoding.

The plurality of diversity branches may include at least one of a plurality of antennae or rake receivers or fingers. The plurality of diversity branches may be independent and have amplitudes following a Nakagami-m distribution. The first subset of the plurality of diversity branches may have a higher average power than each diversity branch of the other diversity branches of the plurality of diversity branches. Determining the second subset of the plurality of diversity branches may include calculating the instantaneous power of each diversity branch of the plurality of diversity branches.

In another aspect, the subject matter is embodied in a transceiver for a wireless communication system. The transceiver may include one or more processors. The one or more processors may be configured to determine a joint average channel characteristic for each diversity branch of a plurality of diversity branches, at least one diversity branch of the plurality of diversity branches having a signal. The one or more processors may also be configured to determine an optimal size of a first subset of the plurality of diversity branches based on the joint average channel characteristics. The one or more processors may also be configured to determine an optimal choice of diversity branches for the first subset based on the joint average channel characteristics. The one or more processors may also be configured to determine a number of pilot transmissions required based on the optimal choice of diversity branches for the first subset. The one or more processors may also be configured to determine instantaneous channel state information for each diversity branch of the first subset based on the pilot transmissions. The one or more processors may also be configured to determine a second subset of the plurality of diversity branches based on the instantaneous channel state information, the second subset being a subset of the first subset. The one or more processors may also be configured to perform an up/down-conversion on the second subset and decode one or more signals based on the second subset.

In another aspect, the subject matter is embodied in a wireless communications system. The system may include a plurality of diversity branches, at least one diversity branch of the plurality of diversity branches having a signal. The system may also include a transceiver having one or more processors. The one or more processors may be configured to determine a joint average channel characteristic for each diversity branch of a plurality of diversity branches, at least one diversity branch of the plurality of diversity branches having a signal. The one or more processors may also be configured to determine an optimal size of a first subset of the plurality of diversity branches based on the joint average channel characteristics. The one or more processors may also be configured to determine an optimal choice of diversity branches for the first subset based on the joint average channel characteristics. The one or more processors may also be configured to determine a number of pilot transmissions required based on the optimal choice of diversity branches for the first subset. The one or more processors may also be configured to determine instantaneous channel state information for each diversity branch of the first subset based on the pilot transmissions. The one or more processors may also be configured to determine a second subset of the plurality of diversity branches based on the instantaneous channel state information, the second subset being a subset of the first subset. The one or more processors may also be configured to perform and up/down-conversion on the second subset and decode one or more signals based on the second subset.

### BRIEF DESCRIPTION OF THE DRAWINGS

Other systems, methods, features, and advantages of the present invention will be apparent to one skilled in the art upon examination of the following figures and detailed description. Component parts shown in the drawings are not necessarily to scale, and may be exaggerated to better illustrate the important features of the present invention.

FIG. 1 shows the relevant distribution parameters of a diversity path according to an aspect of the invention.

FIG. 2A shows the capacity of a system as a function of the size of a subset for an exponential average power spectrum across the diversity branches according to an aspect of the invention.

FIG. 2B shows the capacity of a system as a function of the size of a subset for a Gaussian average power spectrum across the diversity branches according to an aspect of the invention.

FIG. 3 shows a summary of the simulation parameters for an ultra-wide band (UWB) system and a single input multiple output (SIMO) system according to an aspect of the invention.

FIG. 4A shows the achievable rates for an UWB system according to an aspect of the invention.

FIG. 4B shows the achievable rates for a SIMO system according to an aspect of the invention.

FIG. 5 shows an example block diagram of a wireless communication system according to an aspect of the invention.

FIG. 6 shows a flow diagram of an example process implemented by a transceiver of a wireless communication system according to an aspect of the invention.

### DETAILED DESCRIPTION

Disclosed herein are systems, methods, and apparatus for an optimal achievable data rate for wireless communications with low complexity switched transceivers. In a switched transceiver with N diversity branches and K up/down-conversion chains, not all diversity branches have the same average power in practice. For example, in multi-antenna transceivers with lens based architectures or with beam selection, the different effective beams that are available at the output of the analog beamformer for selection carry different powers. Consequently, some diversity branches might make only a minor contribution to boosting the system capacity. On the other hand, the channel estimation overhead for acquiring the channel state information (CSI) of these branches increases linearly with [L/K]. Therefore, CSI may be acquired for only a subset of L paths, where K≤L≤N, and L is a trade-off between the estimation overhead and the performance gain from increased diversity. The determination of the subset may be based only on second-order statistics of all the diversity paths. The second-order statistics change very slowly with time and can be easily tracked at the receiver (RX) with low estimation overhead.

The notation followed in this description is as follows: Scalars are represented by light-case letters; vectors by bold-case letters; matrices by capitalized bold-case letters; and sets by calligraphic letters. Additionally, aᵢ represents the i-th element of a vector a and | [symbol] | the cardinality of a set [symbol] . Also, [symbol] { } represents the expectation operator, [symbol] _{A} the A×A identity matrix, [symbol] _{A×B} the A×B all-zero matrix, ┌a┐ the smallest integer larger than a and fₓ, Fₓ the probability density and cumulative distribution for a random variable x, respectively.

A generalized selection combining (GSC) with a single antenna (TX) may first be considered. The channel offers N diversity paths at the RX and the RX may only pick K diversity paths for down-conversion. It may be assumed that N is a multiple of K, without loss of generality. Under this assumption, the base-band equivalent received signal vector during any symbol duration may be represented by the below equation.

y=\sqrt{ρ}Shx+Sn Equation 1:

In the above equation, y is the K×1 received signal vector corresponding to the K down-conversion chains, ρ is the average signal-to-noise ratio (SNR), S is a K×N sub-matrix of [symbol] _{N} that picks the best K branches for down-conversion, h is the N×1 normalized channel vector corresponding to the N diversity paths, x is the transmit data symbol and n˜ [symbol] [symbol] ( [symbol] _{N×N}, [symbol] _{N}) is the N×1 normalized additive white Gaussian noise vector. The channel diversity paths hᵢ are assumed to be independent but not identically distributed (i.n.i.d) and their amplitudes follow a Nakagami-m distribution with the probability density function represented by the below equation.

$${f}_{\vert {h}_{i} \vert} ( x ) = \frac{2 {m}^{m}}{Γ ( m ) {Ω}_{i}^{m}} {x}^{2 m - 1} exp \{ - \frac{{mx}^{2}}{{Ω}_{i}} \} \qquad Equation 2$$

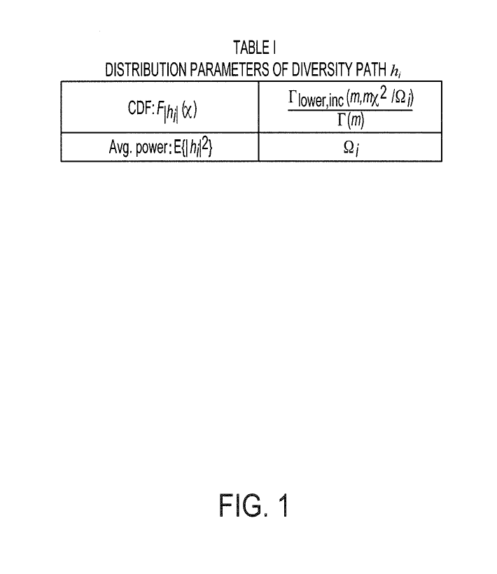

In the above equation, the shape parameter (m) is fixed but the spread parameter (Ωᵢ) may be different for each diversity path i. The channel may be normalized such that Σᵢ₌₁^{N}Ωᵢ=N. FIG. 1 illustrates some of the relevant distribution parameters of hᵢ. It may be assumed that the RX has knowledge of the average power E{|hᵢ|²}=Ωᵢ for all the N paths. Since the average power changes very slowly, it can be tracked for all the N paths with low estimation overhead.

The channel may be assumed to be block fading, wherein the channel stays constant for a coherence time interval and then changes to another random realization with the distribution as in equation 2. During each coherence time interval, the pilot sequence is re-transmitted L/K times to acquire the CSI for L diversity paths K≤L≤N. The CSI acquisition set [symbol] ⊆{1, . . . , N} may be defined as the set of indices of L diversity paths whose CSI is acquired at the RX. The instantaneous SNR for GSC may be represented by the below equation.

$${γ}_{GSC} ( ℒ ) = {max}_{𝒮 ⊆ ℒ , \vert 𝒮 \vert = K} \{ ρ {\sum }_{i ∈ 𝒮} {\vert {h}_{i} \vert}^{2} \} \qquad Equation 3$$

The achievable data rate may be represented by the below equation.

R( [symbol] )=(1−┌L/K┐θₚ)C( [symbol] ) Equation 4:

In the above equations, C( [symbol] )= [symbol] {log(1+γ_{GSC}( [symbol] ))} is the ergodic capacity and θₚ is the fraction of time-frequency resources consumed by the pilot sequence. From equation 4, there may be a trade-off between the number of diversity branches used L and the amount of CSI training required ┌L/K┐θₚ. The CSI acquisition set [symbol] ₒₚₜ and its size Lₒₚₜ=| [symbol] ₒₚₜ| may be found that result in the optimal achievable data rate.

The family of optimization problems for K≤L≤N may be represented by the below equation.

[symbol]

*(L)= [symbol] R( [symbol] ) Equation 5:

The rate maximizing CSI acquisition set may be expressed as [symbol] ₒₚₜ= [symbol] *(Lₒₚₜ) where [symbol] ₒₚₜ is represented by the below equation.

Lₒₚₜ=argmax_{K≤L≤N}{R( [symbol] *(L))} Equation 6:

An optimal solution [symbol] *(L) to equation 5 is represented by the below equation.

[symbol]

*(L)={η₁η₂ . . . η_{L}} Equation 7:

In the above equation, η is a permutation of the vector [1, . . . , N] such that δᵢ≥Ωⱼ for all i≤j. The proof of the above equation is as follows. Assume {η₁, η₂, . . . , η_{L}} is not an optimal solution to equation 5. Consider any optimal solution [symbol] *(L)≠{η₁ η₂ . . . η_{L}}. Then there exists distinct numbers a₁, . . . , aₚ, b₁, . . . , bₚ (where 1≤a₁, . . . , aₚ≤L≤b₁, . . . , bₚ≤N) such that ( [symbol] (L)∪{ηₐ_{₁}, . . . , ηₐ_{ₚ}})\{η_{b}_{₁}, . . . , η_{b}_{ₚ}}={η₁, . . . , η_{L}}. From the definition of η results in

$${Ω}_{{η}_{{a}_{j}}} \geq {Ω}_{{η}_{{b}_{j}}}$$

for all 1≤j≤p. From equation 3 results in the below equation.

$${γ}_{GSC} ( {ℒ}^{*} ( L ) ) = {max}_{𝒮 ⊆ {ℒ}^{*} ( L ) , \vert 𝒮 \vert = K} \{ ρ {\sum }_{i ∈ 𝒮} {\vert {h}_{i} \vert}^{2} \} \leq {max}_{𝒮 ⊆ {ℒ}^{*} ( L ) , \vert 𝒮 \vert = K} \{ ρ {\sum }_{i ∈ 𝒮} {α}_{i} {\vert {h}_{i} \vert}^{2} \} \qquad Equation 8$$

The constants in the above equation may be represented by the below equation.

$${α}_{i} = \{ \begin{matrix}\frac{{Ω}_{{η}_{{a}_{j}}}}{{Ω}_{{η}_{{b}_{j}}}} & for i = {η}_{{b}_{j}} , 1 \leq j \leq p \\ 1 & otherwise\end{matrix} \qquad Equation 9$$

It may be verified from equation 2 that

$$\vert {h}_{{η}_{{a}_{j}}} \vert {=}^{d} \sqrt{{α}_{{η}_{{b}_{j}}}} \vert {h}_{{η}_{{b}_{j}}} \vert ∀ j ,$$

where [symbol] denotes equality in distribution. Since hᵢ is independently distributed for 1≤i≤N, from equation 8 result in the below equation.

$${γ}_{GSC} ( \{ {η}_{1} , … , {η}_{L} \} ) {=}^{d} {max}_{𝒮 ⊆ {ℒ}^{*} ( L ) , \vert 𝒮 \vert = K} \{ ρ {\sum }_{i ∈ 𝒮} {α}_{i} {\vert {h}_{i} \vert}^{2} \} ⇒ {γ}_{GSC} ( \{ {η}_{1} , … , {η}_{L} \} ) {\geq }^{d} {γ}_{GSC} ( {ℒ}^{*} ( L ) ) \qquad Equation 10$$

In the above equation, [symbol] represents first order stochastic dominance of the left hand side over the right hand side. Using equations 4 and 10 results in the below equation.

R( [symbol] *(L))≤R({η₁, . . . ,η_{L}}) Equation 11:

The above equation contradicts the above disclosed initial assumption. This concludes the proof.

Since it is now known how to find [symbol] *(L), the problem of finding [symbol] ₒₚₜ may be reduced to finding optimal size Lₒₚₜ in equation 6.

C( [symbol] *(L)) satisfies the following equation, and is therefore a non-negative, non-decreasing and concave function of L.

ΔC_{L+1}≤ΔC_{L} for K≤L≤N−1 Equation 12:
where ΔC_{L} [symbol] C( [symbol] *(L))−C( [symbol] *(L−1))

The proof of the above equation is as follows. Since [symbol] *(L)⊂ [symbol] *(L+1), from equations 3 and 4, C( [symbol] *(L)) is a non-negative, non-decreasing function of L. For any L, consider a new random vector ĥ such that: ĥ_{η}_{ᵢ}=h_{η}_{ᵢ} for i∉{L, L+1}, ĥ_{η}_{_{L}} [symbol] h_{η}_{_{L}} but is independent of h, and ĥ_{η}_{_{L+1}}=h_{η}_{_{L}}{square root over (Ω_{η}_{_{L+1}}/Ω_{η}_{_{L}})}. It can be verified from equation 2 that ĥ [symbol] h. Let |h₍ᵢ₎^{L}|, |ĥ₍ᵢ₎^{L}| represent magnitude of the i-th largest diversity paths (in magnitude) from the sets {|hⱼ∥j∈ [symbol] *(L)} and {|ĥⱼ∥j∈ [symbol] *(L)}, respectively. Then from equation 3 results in the below equations.

$$\begin{matrix}{γ}_{GSC} ( {ℒ}^{*} ( L ) ) = {\sum }_{i = 1}^{K} ρ {\vert {h}_{( i )}^{L} \vert}^{2} & Equation 13 \\ \begin{matrix}{Δγ}_{GSC} ( L ) {=}^{Δ} {γ}_{GSC} ( {ℒ}^{*} ( L ) ) - {γ}_{GSC} ( {ℒ}^{*} ( L - 1 ) ) \\ = max \{ ρ {\vert {h}_{( K )}^{L - 1} \vert}^{2} \cdot ρ {\vert {h}_{{η}_{L}} \vert}^{2} \} - ρ {\vert {h}_{( K )}^{L - 1} \vert}^{2}\end{matrix} & Equation 14\end{matrix}$$

The incremental capacity may be expressed as the below equation.

$$Δ {C}_{L} = C ( {ℒ}^{*} ( L ) ) - C ( {ℒ}^{*} ( L - 1 ) ) = 𝔼 \{ {\int }_{0}^{{Δγ}_{GSC} ( L )} \frac{1}{1 + {γ}_{GSC} ( {ℒ}^{*} ( L - 1 ) ) + x} dx \} \qquad Equation 15$$

The below equation results from ĥ [symbol] h.

$$Δ {C}_{L + 1} = 𝔼 \{ {\int }_{0}^{Δ {\hat{γ}}_{GSC} ( L + 1 )} \frac{1}{1 + {\hat{γ}}_{GSC} ( {ℒ}^{*} ( L ) ) + x} dx \} \qquad Equation 16$$

In the above equations, \hat{γ}_{GSC}( [symbol] *(L)), Δ\hat{γ}_{GSC}(L+1) are as in equations 13 and 14 with terms of h replaced by corresponding terms of ĥ. As [symbol] *(L−1)⊂ [symbol] *(L), from the definition of ĥ it can be verified that |ĥ_{(K)}^{L}|≥|h_{(K)}^{L-1}| and \hat{γ}_{GSC}( [symbol] *(L))≥γ_{GSC}( [symbol] *(L−1)) for all channel realizations. Additionally, using equation 7, ĥ_{η}_{_{L+1}}≤h_{η}_{_{L}} results in Δ\hat{γ}_{GSC}(L+1)≤Δγ_{GSC}(L). Using these results and equations 15 and 16, equation 12 follows.

Combining equation 4 with the fact that C( [symbol] *(L)) is a non-decreasing function of L results in: R( [symbol] *(L))≤R( [symbol] *(K┌L/K┐)) for all K≤L≤N. The optimization problem in equation 6 may simplified in the below equation.

Lₒₚₜ=argmax_{L∈{K,2K, . . . ,N}}{R( [symbol] *(L))} Equation 17:

For ease of notation, define C( [symbol] *(0))=C( [symbol] *(N+K))=0. Then any L*∈{K, 2K, . . . , N} is a local maximum of equation 17 iff:

$$\begin{matrix}R ( {ℒ}^{*} ( {L}^{*} - \vert K ) ) \leq \vert R ( {ℒ}^{*} ( {L}^{*} ) ) \geq R ( {ℒ}^{*} ( {L}^{*} + K ) ) ≡ Δ {C}_{{L}^{*}}^{K} \geq g ( {L}^{*} ) and {Δ C}_{{L}^{*} + K}^{K} \leq g ( {L}^{*} + K ) \\ where Δ {C}_{{L}^{*}}^{K} = C ( {ℒ}^{*} ( {L}^{*} ) ) - C ( {ℒ}^{*} ( {L}^{*} - K ) ) and \text{:} & Equation 18 \\ g ( L ) {=}^{Δ} \frac{C ( {ℒ}^{*} ( L - K ) )}{\frac{1}{{θ}_{p}} - \frac{L}{K}} & Equation 19\end{matrix}$$

From equation 12, ΔC_{L}^{K} (is a non-increasing function of L and g(L) is a non-decreasing function of L. Therefore, any locally optimum L* for equation 17 is also a globally optimum solution. Therefore, instead of a brute-force search, the following linear search algorithm may be used to find Lₒₚₜ which requires computation of C( [symbol] *(L)).

Algorithm 1: Find Lₒₚₜ

```
N,K,m,p,Ω - inputs
Initialize L = K;C(L*(0)) = 0;
while L < N do
  Compute C(L*(L));
  Compute C(L*(L + K));
  if ΔC_{L}^{K} ≥ g(L) and ΔC_{L+K}^{K} ≤ g(L + K) then
    return L;
  end if
  L = L + K:
end while
return N
```

Most of the prior works to compute ( [symbol] *(L)), rely on finding the moment generating function (MGF) of the SNR. Finding the MGF is in itself a computationally intensive exercise involving

$$\approx K ( \begin{matrix}L \\ K\end{matrix} )$$

one-dimensional integrals in general. Therefore, techniques to find the capacity from the MGF become computationally cumbersome. While those methods can be used in principle as part of the present disclosure, another realization of the present disclosure relies on the upper bound on capacity to find a near-optimal Lₒₚₜ in algorithm 1, represented by the below equation.

C_{UB}( [symbol] ) [symbol] log(1+ [symbol] {γ_{GSC}( [symbol] )})≥C( [symbol] ) Equation 20:

It can be verified that equations 7 and 12 are also applicable if C( [symbol] ) is replaced by C_{UB}( [symbol] ). Computing C_{UB}( [symbol] ), which is a function of the mean SNR, is also an involved exercise involving

$$\approx {K}^{2} ( \begin{matrix}L \\ K\end{matrix} )$$

one-dimensional integrals. Though some works also find closed form results, they involve a larger number of iterations and thus do not necessarily reduce the computational complexity. This computational load can be very large especially if K and/or L are large and therefore alternate approaches are required. Observing that C_{UB}( [symbol] *(L−K)) is known while finding C_{UB}( [symbol] *(L)) in algorithm 1, it can be recursively defined by the below equation.

[symbol]

= [symbol] + [symbol] Equation 21:

Using equation 14, the below equations are defined.

$$\begin{matrix}𝔼 \{ {Δγ}_{GSC} ( L ) \} = {\int }_{x = 0}^{∞} {x}^{2} [ {F}_{\vert {h}_{( K )}^{L - 1} \vert} ( x ) {f}_{\vert {h}_{{η}_{L}} \vert} ( x ) - {f}_{\vert {h}_{( K )}^{L - 1} \vert} ( x ) ( 1 - {F}_{\vert {h}_{{η}_{L}} \vert} ( x ) ) ] dx & Equation 22 \\ {f}_{\vert {h}_{( K )}^{L - 1} \vert} ( x ) = {\sum }_{b ∈ {𝒫}_{L - 1}^{( 1 : K - 1 , K + 1 : L - 1 )}} {f}_{\vert {h}_{{b}_{K}} \vert} ( x ) [ {\prod }_{i = 1}^{K - 1} ( 1 - {F}_{\vert {h}_{{b}_{i}} \vert} ( x ) ) ] \times [ {\prod }_{j = K + 1}^{L - 1} {F}_{\vert {h}_{{b}_{j}} \vert} ( x ) ] & Equation 23 \\ {F}_{\vert {h}_{( K )}^{L - 1} \vert} ( x ) = {\sum }_{k = 0}^{K - 1} {\sum }_{b ∈ {𝒫}_{L - 1}^{( 1 : k , k + 1 : L )}} [ {\prod }_{i = 1}^{k} ( 1 - {F}_{\vert {h}_{{b}_{i}} \vert} ( x ) ) ] \times [ {\prod }_{j = k + 1}^{L - 1} {F}_{\vert {h}_{{b}_{j}} \vert} ( x ) ] & Equation 24\end{matrix}$$

In the above equations, [symbol] _{L-1}^{(a:b,c:d)} is a set of all permutations of the vector [η₁, . . . , η_{L-1}] such that ∀b∈ [symbol] _{L-1}^{(a:b,c:d)}, bₐ<bₐ₊₁< . . . <b_{b} and b_{c}<b_{c+1}< . . . <b_{d}. In general, this recursive definition does not lead to any significant savings in computing C_{UB}( [symbol] (L)). However, in the special case where [symbol] *(L−1) has independent and identically distributed (i.i.d.) diversity paths, results in the below equations:

$$\begin{matrix}{f}_{\vert {h}_{( K )}^{L - 1} \vert}^{iid} ( x ) = K ( \begin{matrix}L - 1 \\ K\end{matrix} ) {f}_{\vert {h}_{L - 1}^{iid} \vert} ( x ) {( 1 - {F}_{\vert {h}_{L - 1}^{iid} \vert} ( x ) )}^{K - 1} \times {( {F}_{\vert {h}_{L - 1}^{iid} \vert} ( x ) )}^{L - K - 1} & Equation 25 \\ {F}_{\vert {h}_{( K )}^{L - 1} \vert}^{iid} ( x ) = {\sum }_{k = 0}^{K - 1} ( \begin{matrix}L - 1 \\ K\end{matrix} ) {( 1 - {F}_{\vert {h}_{L - 1}^{iid} \vert} ( x ) )}^{k} \times {( {F}_{\vert {h}_{L - 1}^{iid} \vert} ( x ) )}^{L - k - 1} & Equation 26 \\ 𝔼 \{ {γ}_{GSC}^{iid} ( {ℒ}^{*} ( L - 1 ) ) \} = {\sum }_{k = 1}^{K} k ( \begin{matrix}L - 1 \\ k\end{matrix} ) {\int }_{x = 0}^{∞} [ {x}^{2} {f}_{\vert {h}_{L - 1}^{iid} \vert} ( x ) \times {( 1 - {F}_{\vert {h}_{L - 1}^{iid} \vert} ( x ) )}^{k - 1} {( {F}_{\vert {h}_{L - 1}^{iid} \vert} ( x ) )}^{L - k - 1} ] dx & Equation 27\end{matrix}$$

In the above equations,

$${f}_{\vert {h}_{L - 1}^{iid} \vert} ( x )$$

and

$${F}_{\vert {h}_{L - 1}^{iid} \vert} ( x )$$

are the marginal PDF and CDF, respectively, of |hᵢ|∀i∈ [symbol] *(L−1). In this case, computing C_{UB}( [symbol] (L)) from C_{UB}( [symbol] *(L−1)) only involves computing K one-dimension integrals.

To reduce the cost of computation in the general i.n.i.d. case, while computing [symbol] {Δ\tilde{γ}_{GSC}(L)}, from equation 22, [symbol] *(L−1) is approximated to be composed of i.i.d. components. Where, \tilde{X} is used to denote an approximation for X, (X=γ_{GSC}, C_{UB}). An approximation of

$${f}_{\vert {h}_{( K )}^{L - 1} \vert} ( x ) and {F}_{\vert {h}_{( K )}^{L - 1} \vert} ( x ) by {f}_{\vert {h}_{( K )}^{L - 1} \vert}^{iid} ( x ) and {F}_{\vert {h}_{( K )}^{L - 1} \vert}^{iid} ( x ) ,$$

respectively, is considered, where the i.i.d. spreading parameter Ω_{L-1}^{iid} is chosen such that: [symbol] {γGSC^{iid}( [symbol] *(L−1))}= [symbol] {\tilde{γ}_{GSC}( [symbol] *(L−1))}. From equation 21, [symbol] {\tilde{γ}_{GSC}( [symbol] *(L−1))} is available when computing {Δ\tilde{γ}_{GSC}(L)}.

The above procedure is detailed in the below Algorithm 2 and may be referred to as “RecursiveIID Approx.”

Algorithm 2: Compute \tilde{C}_{UB} ( [symbol] *(L)) recursively¹²

```

[symbol]
{\tilde{γ}_{GSC}( [symbol] *(L − 1))}, L, K, m, ρ, Ω_{ηL} - inputs
if L ≤ K then
  return
  \tilde{C}_{UB} ( [symbol] *(L)) = log(1 + [symbol] {\tilde{γ}_{GSC}( [symbol] *(L − 1))} + ρΩ_{ηL})
end if
Find Q_{L - 1}^{iid} s.t. [symbol]
      {γ_{GSC}^{iid}( [symbol] *(L − 1))} = [symbol] {\tilde{γ}_{GSC}( [symbol] *(L − 1))} + ρΩ_{ηL})
where [symbol] {γ_{SC}^{iid}( [symbol] *(L − 1))} is as detained in (27) and;
    ${f}_{\vert {h}_{L - 1}^{iid} \vert} ( x ) {=}^{△} {\frac{2}{Γ ( m )} [ \frac{m}{{Ω}_{L - 1}^{iid}} ]}^{m} {x}^{2 m - 1} exp \{ - \frac{{mx}^{2}}{{Ω}_{L - 1}^{iid}} \}$
        ${f}_{\vert {h}_{L - 1}^{iid} \vert} ( x ) {=}^{△} \frac{{Γ}_{lower , inc} ( m , {mx}^{2} / {Ω}_{L - 1}^{iid} )}{Γ ( m )}$
{For example,0 using FSOLVE in MATLAB}
compute [symbol] {Δ\tilde{γ}_{GSC}(L)} from (22) with
\tilde{f}_{|h}_{_{(K)}}_{^{L − 1}}_{|} (x),F_{|h}_{_{(K)}}_{^{L − 1}}_{|} (x) as given by (25)-(26). [symbol]
{\tilde{γ}_{GSC}( [symbol] *(L))} = [symbol] {\tilde{γ}_{GSC}( [symbol] *(L − 1))} + [symbol] {Δ\tilde{γ}_{GSC}(L)}
return \tilde{C}_{UB} ( [symbol] *(L)) = log(1 + [symbol] {\tilde{γ}_{GSC}( [symbol] *(L − 1))})
```

The proposed approximation is accurate when either the spreading parameters Ωᵢ may be equal for some i and negligible for others or are skewed such that Kᵢ₌₁^{K}Ωᵢ>>Σ_{i=K+1}^{N}Ωᵢ.

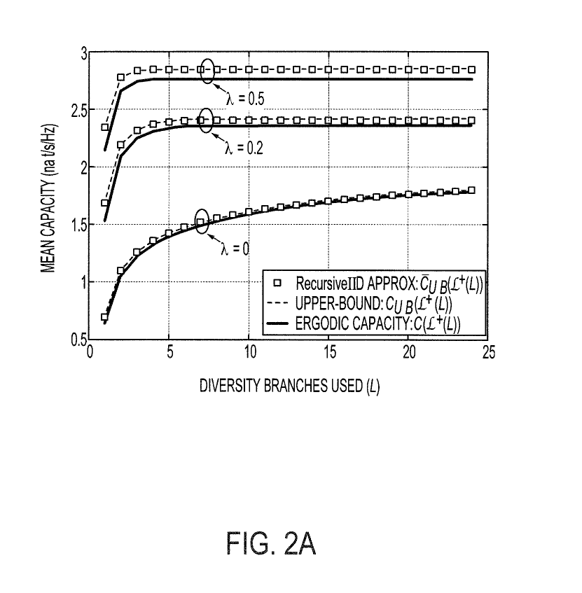

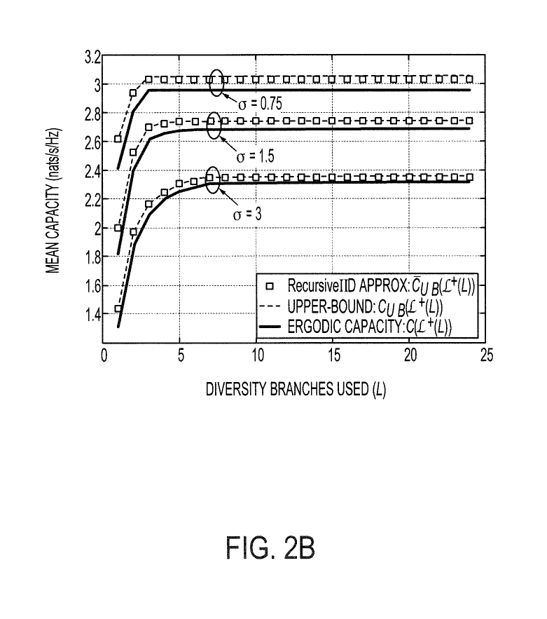

FIGS. 2A and 2B illustrate a study of the accuracy of the approximation for several practically relevant power spectra (Ω). FIG. 2A considers an exponential power spectrum, truncated exponential, Ωᵢ=κ exp{−ρi}. FIG. 2B considers a Gaussian power spectrum, truncated Gaussian,

$${Ω}_{i} = κ exp \{ - \frac{{( i - ⌊ N / 2 ⌋ )}^{2}}{2 {σ}^{2}} \} ,$$

where the system parameters are m=2, N=24, K=2, and ρ=1. The ergodic capacity C( [symbol] *(L)), as obtained via Monte-Carlo simulations, are compared to both the capacity upper bound C_{UB}( [symbol] *(L)), as also obtained via Monte-Carlo simulations, and the Recursive IID Approximation \tilde{C}_{UB}( [symbol] *(L)) is obtained via Algorithm 2 described above.

The results show that Recursive-IID Approximation provides a very good approximation to C_{UB}( [symbol] *(L)). Although there is a gap between C( [symbol] *(L)) and \tilde{C}_{UB}(L*(L)), the gap is constant. The below simulation results show that the impact on this gap on Lₒₚₜ is minimal. Similar results may be observed for other power spectra, barring a few heavy tail distributions like the Zipf distribution.

Simulation Results

For simulations, a system may be considered with a single antenna TX and a low complexity switched RX. Two relevant scenarios may be considered. The first, a UWB system with impulse radio signaling and an S-Rake RX. The second, an orthogonal frequency division multiplexed SIMO system with a multi-antenna RX. For finding the pilot overhead, it may be assumed that there are U such that single antenna TXs in the system. Orthogonal pilots are assigned to the TXs to prevent pilot contamination.

The fractional pilot overhead in the two above mentioned cases is computed as

$${θ}_{p}^{UWB} \approx \frac{{T}_{symb} U}{{T}_{coh}} and {θ}_{p}^{MIMO} \approx \frac{{τ}_{rms} U}{{T}_{coh}} .$$

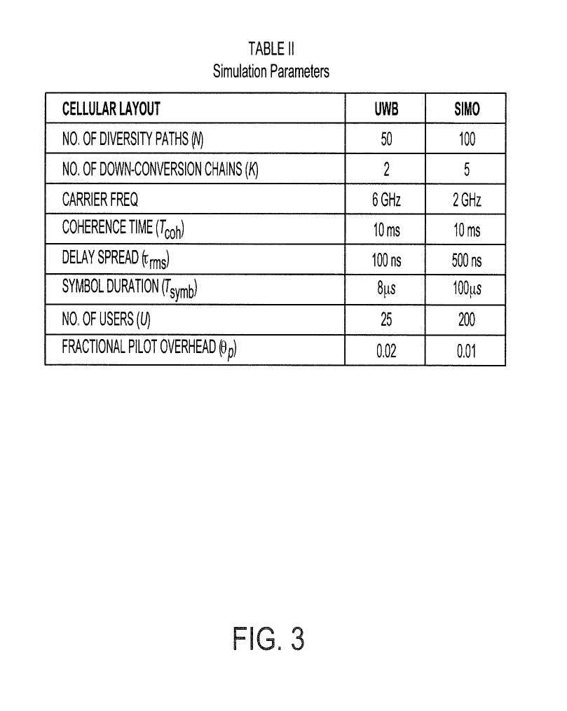

The simulation parameters are summarized in FIG. 3 and are similar to the parameters in IEEE 802.15.4a Personal Area Network (PAN) standard and the cellular Long Term Evolution (LTE) standard, respectively.

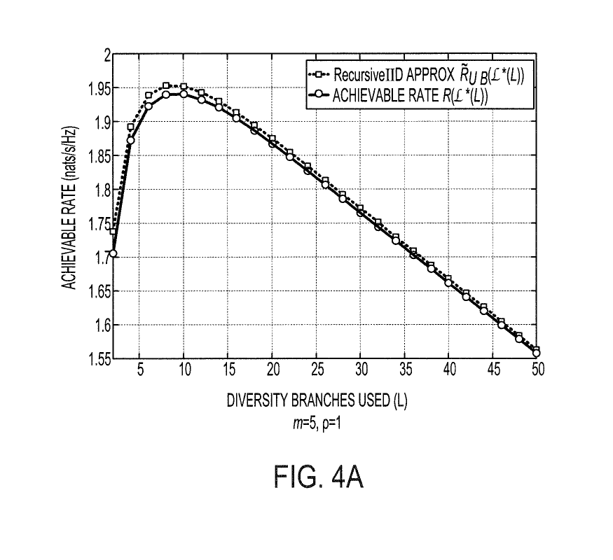

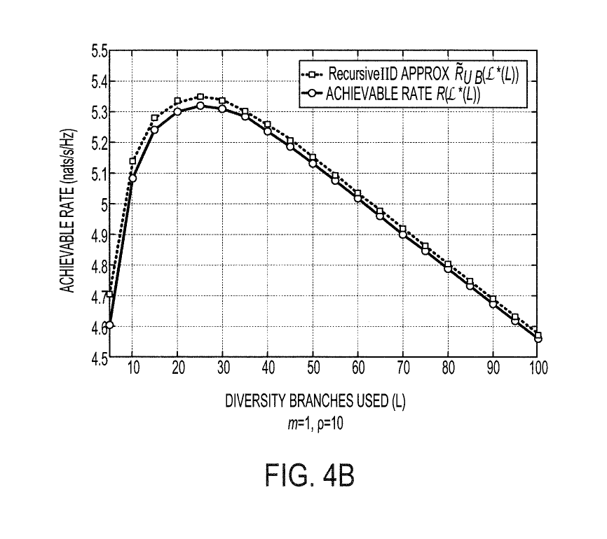

Assuming that the multiple TXs have orthogonal access in time, frequency, or space (i.e. no interference), one can restrict to a single TX-RX analysis as has been described herein. The achievable rates for the two scenarios as a function of L are illustrated in FIGS. 4A and 4B. FIG. 4A illustrates a UWB system represented by the equation

$${Ω}_{i} = κ {\sum }_{j = 1}^{6} exp \{ - \frac{j}{25} - \frac{2 i - 10 j}{15} \} u [ 2 i - 10 j ] ,$$

where u[i]=1 for i≥0 and u[i]=0 otherwise. FIG. 4B illustrates a SIMO system represented by the equation

$${Ω}_{i} = κ {\sum }_{j = 1}^{20} {( j / 20 )}^{2} exp \{ \frac{{[ 1.8 ( i - 50 ) - {φ}_{j} ]}^{2}}{50} \} , \\ where {φ}_{j } = 36 {( - 1 )}^{j} \sqrt{- 2 log ( j / 20 )} .$$

The achievable rate R( [symbol] *(L)), as obtained via Monte-Carlo simulations) are compared to the Recursive-IID Approximations \tilde{R}_{UB}( [symbol] *(L)), as obtained via Algorithms 2 and 4. The results suggest that the proposed Recursive IID algorithm predicts the value of Lₒₚₜ accurately. Also, Lₒₚₜ<<N and this leads to a significant increase in achievable data rate, approximately by 20-30%.

Under typical scenarios Lₒₚₜ>K, which suggests that with judicious pilot training, Selective-Rake RX outperforms Partial-Rake RX and introducing a selection stage improves performance of MIMO hybrid beamforming even after accounting for training overhead.

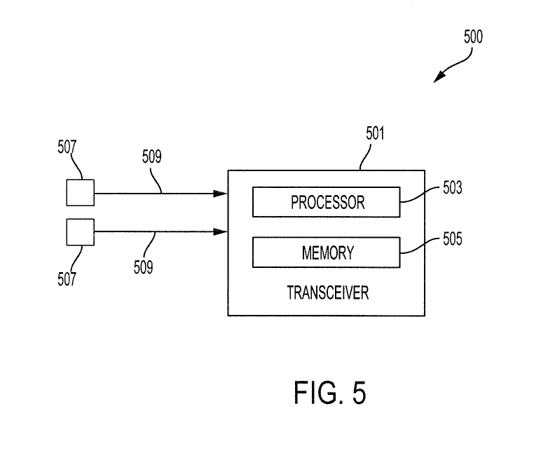

FIG. 5 is an example block diagram of a wireless communication system 500. The system 500 includes a transceiver 501 and a plurality of diversity branches 507. In some embodiments, the transceiver 501 may be a receiver or a transmitter.

The plurality of diversity branches 507 may emit one or more signals 509. In some embodiments the plurality of diversity branches 507 may include at least one of a plurality of antennae, selection ports of an analog beamformer, polarization ports, or rake receivers or fingers. However, other forms of diversity branches 507 may be used interchangeably according to various embodiments.

The transceiver 501 may include one or more processors 503 and a memory 505. In some embodiments, the transceiver 501 may include only the one or more processors 503.

The memory 505 may be a non-transitory memory or a data storage device, such as a hard disk drive, a solid-state disk drive, a hybrid disk drive, or other appropriate data storage, and may further store machine-readable instructions, which may be loaded and executed by the one or more processors 503. The memory 505 may store a firmware update to the transceiver 501.

The transceiver 501 may receive the one or more signals 509 from the plurality of diversity branches 507. The transceiver 501 may perform algorithmic operations on the one or more signals 509 to achieve an optimal performance criterion for a wireless communication system. In some embodiments, the algorithmic operations may be performed by the one or more processors 503. The algorithmic operations may be stored in the memory 505. In some embodiments, the algorithmic operations may include a sequence of more detailed operations.

The transceiver 501 may include a network access device in operable communication with the one or more processors 503 and a network. The network access device may include a communication port or channel, such as one or more of a Wi-Fi unit, a Bluetooth® unit, a radio frequency identification (RFID) tag or reader, or a cellular network unit for accessing a cellular network (such as 3G, 4G or 5G). The network access device may transmit data to and receive data from devices and systems not directly connected to the transceiver 501. The network may be a Bluetooth Low Energy (BLE) network, a local area network (LAN), a wide area network (WAN), a cellular network, the Internet, and/or combination thereof.

In some embodiments, the transceiver 501 may include a decoder for decoding the one or more signals 509. In other embodiments, the transceiver 501 may be in operable communication with the decoder.

The transceiver 501 may transmit known pilot sequences. The pilot sequences may be stored in the memory 505 before being transmitted. In other embodiments, the pilot sequences may be transmitted without being stored in any memory. In another embodiment transceiver 501 is a receiver and the pilot sequence is transmitted from a different transmitter. In another embodiment the transceiver 501 may adapt the number of pilot sequences to be transmitted.

In another embodiment, the transmitter sends out multiple data streams, and the receiver determines the first subset based on average channel state information, such as the second-order statistics, and the second subset based on the instantaneous channel state information such that the data rate of the multi-stream receiver is optimized. In some embodiments, the joint average channel characteristic may be an average channel characteristic at each independent diversity branch.

In another embodiment, the system optimizes the antenna subsets for a quality criterion that is different from maximum data rate, such as robustness to interference or outage.

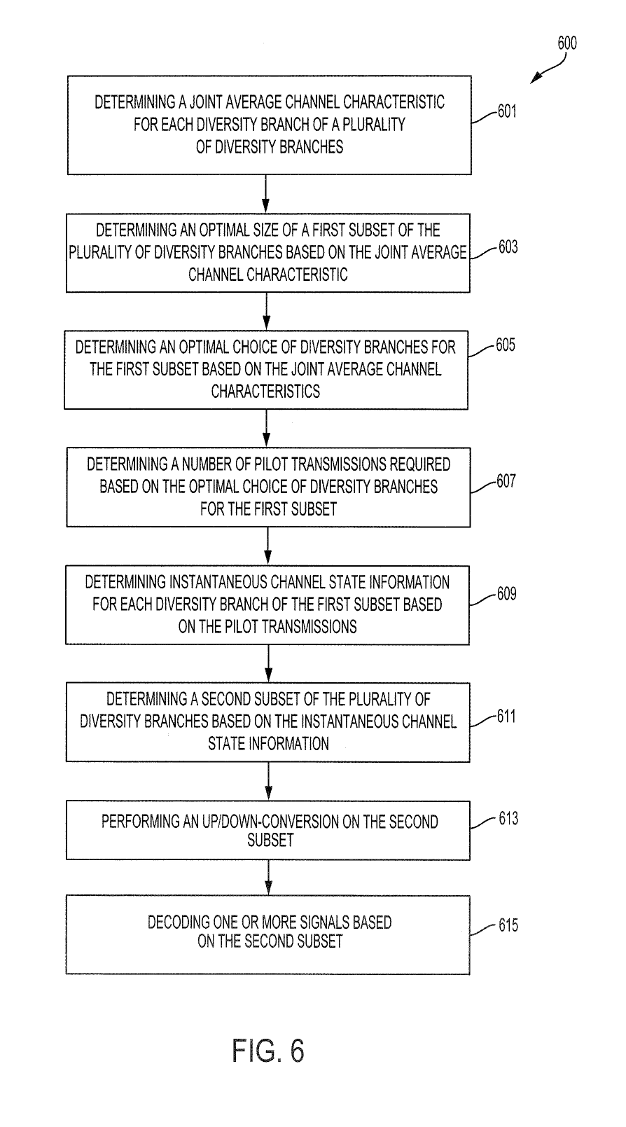

FIG. 6 is a flow diagram of an example process for an optimal performance criterion implemented by a transceiver of a wireless communication system. In some implementations, the example process may be performed by a receiver or a transmitter.

A transceiver may determine a joint average channel characteristic for each diversity branch of a plurality of diversity branches (601). At least one diversity branch of the plurality of diversity branches may have a signal. In some embodiments, the transceiver may determine a correlation matrix between the signals in the diversity branches or other average channel state characteristics. In some embodiments, the plurality of diversity branches may include at least one of a plurality of antennae, analog beamformer ports, polarization ports, or rake receiver or fingers. However, other forms of diversity branches may be used interchangeably according to various embodiments. In some embodiments, the performance criterion may be the achievable data rate and the average channel characteristics of the diversity branches may be the average powers. The joint average channel characteristic may be a correlation matrix of a channel state matrix. In some embodiments, the transceiver may also determine multiple data streams.

The transceiver may determine, by using an algorithm, an optimal size of a first subset of the plurality of diversity branches based on the joint average channel characteristics (603). In some embodiments, the optimal size of the first subset of the plurality of diversity branches may be determined by calculating the average power of each diversity branch of the plurality of diversity branches.

The transceiver may then determine, by using an algorithm, an optimal choice of diversity branches for the first subset based on the joint average channel characteristics (605). In some embodiments, the plurality of diversity branches may be independent and have amplitudes following a Nakagami-m distribution. Determining the first subset of the plurality of diversity branches may include calculating the instantaneous power of each diversity branch of the plurality of diversity branches. In some embodiments, the first subset of the plurality of diversity branches may have a higher average power than each diversity branch of the other diversity branches of the plurality of diversity branches. The optimal size of the first subset may be determined using average branch powers by a fast algorithm.

The transceiver may determine a number of pilot transmissions required based on the optimal choice of diversity branches for the first subset (607). The transceiver may determine instantaneous channel state information for each diversity branch of the first subset based on the pilot transmissions (609). In some embodiments, the transceiver may transmit a known pilot sequence one or more times during a channel coherence time interval. The transceiver may determine the number of pilot transmissions based on the choice of the first subset of diversity branches. The transceiver may receive channel state information in response to transmitting the known pilot sequence. In another embodiment the transceiver may estimate the channel state information using one or more pilot sequences transmitted from a different transmitter. The transceiver may choose the optimal length of the pilot sequence based on the optimal choice of the first subset of diversity branches.

The transceiver may determine a second subset of the plurality of diversity branches based on the instantaneous channel state information (611). The second subset may be a subset of the first subset. In some embodiments, the second subset of the plurality of diversity branches may have a higher average power than each diversity branch of the other diversity branches of the plurality of diversity branches. In some embodiments, the joint average channel characteristic may be an average channel characteristic at each independent diversity branch.

In some implementations, the transceiver may determine that there are two or more signals in the second subset. The transceiver may combine the two or more signals of the second subset for decoding. The transceiver may jointly decode the two or more signals of the second subset. The two or more signals in the second subset may be linearly weighted copies of each other and the joint decoding may be performed through linear combining of the received signals before decoding. In some embodiments, the two or more signals may be different linear combinations of multiple signals. Joint detection may be performed by a multi-stream receiver. The second subset of the plurality of diversity branches may have a higher instantaneous power than each diversity branch of the other diversity branches of the plurality of diversity branches.

The transceiver may perform an up/down-conversion on the second subset (613). The transceiver may decode one or more signals based on the second subset (615). In some embodiments, a dedicated decoder may decode the one or more signals based on the second subset.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only, and is not intended to limit the scope of systems, apparatuses, and methods as disclosed herein, which is defined solely by the claims. Accordingly, the systems, apparatuses, and methods are not limited to that precisely as shown and described.

Certain embodiments of systems, apparatuses, and methods are described herein, including the best mode known to the inventors for carrying out the same. Of course, variations on these described embodiments will become apparent to those of ordinary skill in the art upon reading the foregoing description. The inventor expects skilled artisans to employ such variations as appropriate, and the inventors intend for the systems, apparatuses, and methods to be practiced otherwise than specifically described herein. Accordingly, the systems, apparatuses, and methods include all modifications and equivalents of the subject matter recited in the claims appended hereto as permitted by applicable law. Moreover, any combination of the above-described embodiments in all possible variations thereof is encompassed by the systems, apparatuses, and methods unless otherwise indicated herein or otherwise clearly contradicted by context.

What is claimed is:

1. A method for an optimal performance criterion for a wireless communication system, the method comprising:
determining, using a transceiver, a joint average channel characteristic for each diversity branch of a plurality of diversity branches, at least one diversity branch of the plurality of diversity branches having a signal;
determining, using the transceiver and an algorithm, an optimal size of a first subset of the plurality of diversity branches based on the joint average channel characteristics;
determining, using the transceiver and an algorithm, an optimal choice of diversity branches for the first subset based on the joint average channel characteristics;
determining, using the transceiver, a number of pilot transmissions required based on the optimal choice of diversity branches for the first subset;
determining, using the transceiver, instantaneous channel state information for each diversity branch of the first subset based on the pilot transmissions;
determining, using the transceiver, a second subset of the plurality of diversity branches based on the instantaneous channel state information, the second subset being a subset of the first subset;
performing, using the transceiver, an up/down-conversion on the second subset; and
decoding, using the transceiver, one or more signals based on the second subset.

2. The method of claim 1, wherein the performance criterion is the achievable data rate and the average channel characteristics of the diversity branches are the average powers.

3. The method of claim 2, further comprising:
sending, using the transceiver, multiple data streams; and
wherein the joint average channel characteristic is a correlation matrix of a channel state matrix.

4. The method of claim 1, wherein the plurality of diversity branches comprises at least one of a plurality of antennae, analog beamformer ports, polarization ports, or rake fingers.

5. The method of claim 1, wherein the plurality of diversity branches are independent and have amplitudes following a Nakagami-m distribution.

6. The method of claim 1, wherein the first subset of the plurality of diversity branches has a higher average power than each diversity branch of the other diversity branches of the plurality of diversity branches.

7. The method of claim 1, wherein the optimal size of the first subset is determined using average branch powers by a fast algorithm.

8. A transceiver for a wireless communication system comprising:
one or more processors configured to:
determine a joint average channel characteristic for each diversity branch of a plurality of diversity branches, at least one diversity branch of the plurality of diversity branches having a signal;
determine an optimal size of a first subset of the plurality of diversity branches based on the joint average channel characteristics;
determine an optimal choice of diversity branches for the first subset based on the joint average channel characteristics;
determine a number of pilot transmissions required based on the optimal choice of diversity branches for the first subset;
determine instantaneous channel state information for each diversity branch of the first subset based on the pilot transmissions;
determine a second subset of the plurality of diversity branches based on the instantaneous channel state information, the second subset being a subset of the first subset;
perform an up/down-conversion on the second subset; and
decode one or more signals based on the second subset.

9. The transceiver of claim 8, wherein the plurality of diversity branches comprises at least one of a plurality of antennae, analog beamformer ports, polarization ports, or rake fingers.

10. The transceiver of claim 8, wherein the plurality of diversity branches are independent and have amplitudes following a Nakagami-m distribution.

11. The transceiver of claim 8, wherein the second subset of the plurality of diversity branches has a higher instantaneous power than each diversity branch of the other diversity branches of the plurality of diversity branches.

12. The transceiver of claim 8, wherein determining the first subset of the plurality of diversity branches includes calculating the average power of each diversity branch of the plurality of diversity branches.

13. The transceiver of claim 8, wherein the one or more processors are configured to:
transmit a known pilot sequence during a channel coherence time interval;
receive channel state information in response to transmitting the known pilot sequence; and
choose the optimal length of the pilot sequence based on the optimal choice of the first subset of diversity branches.

14. The transceiver of claim 8, wherein the one or more processors are configured to:
determine that there are two or more signals in the second subset; and
combine the two or more signals of the second subset for decoding.

15. A wireless communication system comprising:
a plurality of diversity branches, at least one diversity branch of the plurality of diversity branches having a signal;
a transceiver having one or more processors configured to:
determine a joint average channel characteristic for each diversity branch of a plurality of diversity branches, at least one diversity branch of the plurality of diversity branches having a signal;
determine an optimal size of a first subset of the plurality of diversity branches based on the joint average channel characteristics;
determine an optimal choice of diversity branches for the first subset based on the joint average channel characteristics;
determine a number of pilot transmissions required based on the optimal choice of diversity branches for the first subset;
determine instantaneous channel state information for each diversity branch of the first subset based on the pilot transmissions;
determine a second subset of the plurality of diversity branches based on the instantaneous channel state information, the second subset being a subset of the first subset;
perform an up/down-conversion on the second subset; and
decode one or more signals based on the second subset.

16. The wireless communication system of claim 15, wherein the plurality of diversity branches comprises at least one of a plurality of antennae, analog beamformer ports, polarization ports, or rake fingers.

17. The wireless communication system of claim 15, wherein the plurality of diversity branches are independent and have amplitudes following a Nakagami-m distribution.

18. The wireless communication system of claim 15, wherein the first subset of the plurality of diversity branches has a higher average power than each diversity branch of the other diversity branches of the plurality of diversity branches.

19. The wireless communication system of claim 15, wherein the one or more processors are configured to:
transmit a known pilot sequence during a channel coherence time interval; and
receive channel state information in response to transmitting the known pilot sequence.

20. The wireless communication system of claim 15, wherein the one or more processors are configured to:
determine that there are two or more signals in the second subset; and
combine the two or more signals of the second subset for decoding.
